(19) United States
(12) Patent Application Publication
(10) Pub. No.: US 2015/0138102 A1
(43) Pub. Date: May 21, 2015

(54) INPUTTING MODE SWITCHING METHOD AND SYSTEM UTILIZING THE SAME

(71) Applicants: INVENTEC CORPORATION, Taipei (TW); Inventec (Pudong) Technology Corporation, Shanghai (CN)

(72) Inventors: Hui CHANG, Taipei (TW); Feng-Ku WANG, Taipei (TW); Shu-Tung CHENG, Taipei (TW); Chen-Hsiang JAO, Taipei (TW); Ming-Hua LEE, Taipei (TW); Chia-Wei CHANG, Taipei (TW)

(73) Assignees: INVENTEC CORPORATION, Taipei (TW); Inventec (Pudong) Technology Corporation, Shanghai (CN)

(21) Appl. No.: 14/229,442

(22) Filed: Mar. 28, 2014

(30) Foreign Application Priority Data
Nov. 21, 2013 (CN) 201310594378.4

(51) Int. Cl. G06F 3/041; G06F 3/01

(52) U.S. Cl. CPC G06F 3/041; G06F 3/017
USPC 345/173

(57) ABSTRACT

An inputting mode switching method and system are provided. The inputting mode switching method is used to an inputting device. The inputting mode switching method comprising receiving a first inputting signal, wherein the first inputting signal is produced by the inputting device sensing a first touch; determining, according the first inputting signal, the first touch is sensed by a first touching unit and a second touching unit; switching a mirror mode for inputting where the first touch is sensed by the first touching unit and the second touching unit; and switching a normal mode or a gesture mode for inputting where the first touch is not sensed by the first touching unit and the second touching unit.

### CROSS REFERENCE

The present application is based on, and claims priority from, China Application Serial Number 201310594378.4, filed on Nov. 21, 2013, the invention of which is hereby incorporated by reference herein in its entirety.

### BACKGROUND

1. Field

The present invention relates to an inputting method and an inputting system, and more particularly to an inputting mode switching method and system utilizing the same.

2. Related Art

A laptop computer is nowadays a commonly used computing device for its portability. A laptop usually has a keyboard and a touching pad near the keyboard so that a user may use such apparatus for inputting, wherein the touching pad is used as a mouse. As such, a computer may have some simple functionality of a mouse without being connected to a mouse.

The keyboard only provides inputting operation functionality while the touch pad only produces mouse operation functionality. When the user needs other inputting operations such as gesture operation, the user needs an additional touching device. However, it cost a lot to have additional touching device(s) connected to the conventional inputting device.

Nowadays, the laptop computer only has a keyboard and a touch pad as its inputting devices. Thus, the operations permitted with the combination of said inputting devices are limited. Hence, to provide a method and a corresponding system to integrate a plurality of inputting devices is needed.

### SUMMARY

In accordance with one or more exemplary embodiment of this invention, an input mode switching method, applicable for an inputting device having a first touching unit and a second touching unit, may comprise the steps of: receiving a first inputting signal, wherein the first inputting signal is produced by the inputting device sensing a first touch;

determining whether the first touch is sensed by a first touching unit and a second touching unit according to the first inputting signal; switching the inputting device to a mirror mode for inputting if the first touch is sensed by the first touching unit and the second touching unit; and switching the inputting device to a normal mode or a gesture mode for inputting if the first touch is not sensed by the first touching unit and the second touching unit.

In accordance with one or more exemplary embodiment of this invention, an input mode switching system may comprise an inputting device and a processing unit. The inputting device may comprise a first touching unit and a second touching unit. The processing unit is connected to the inputting device and applicable for receiving a first inputting signal from the inputting device, determining whether the first touch is sensed by the first touching unit and the second touching unit according to the first inputting signal, switching the inputting device to a mirror mode for inputting if the first touch is sensed by the first touching unit and the second touching unit, and switching the inputting device to a normal mode or a gesture mode for inputting if the first touch is not sensed by the first touching unit and the second touching unit, wherein the first inputting signal is produced by the inputting device sensing a first touch.

In order to make the aforementioned and other features of the present invention more comprehensible, several embodiments accompanied with figures are described in detail below.

### BRIEF DESCRIPTION OF THE DRAWINGS

The present invention will become more fully understood from the detailed description given herein below for illustration only, and thus are not limitative of the present invention, and wherein:

FIG. 1 is a block diagram of an input mode switching system in accordance with one embodiment of this invention;

FIG. 2A illustrates an embodiment of this invention that a user touches the first touching unit and the second touching unit at the same time;

FIG. 2B illustrates an embodiment of this invention that a user touches the first touching unit to make the first touching unit provide a functionality of a keyboard;

FIG. 2C illustrates an embodiment of this invention that a user touches the first touching unit to make the first touching unit provide a functionality of a keyboard;

FIG. 3 is a flow chart of the input mode switching method in accordance with one embodiment of this invention;

FIG. 4 is a flow chart of the step S204 of FIG. 3 in accordance with one embodiment of this invention;

FIG. 5 is a flow chart after the step S303 of FIG. 4 in accordance with one embodiment of this invention; and

FIG. 6 is a flow chart after the step S203 of FIG. 3 in accordance with one embodiment of this invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

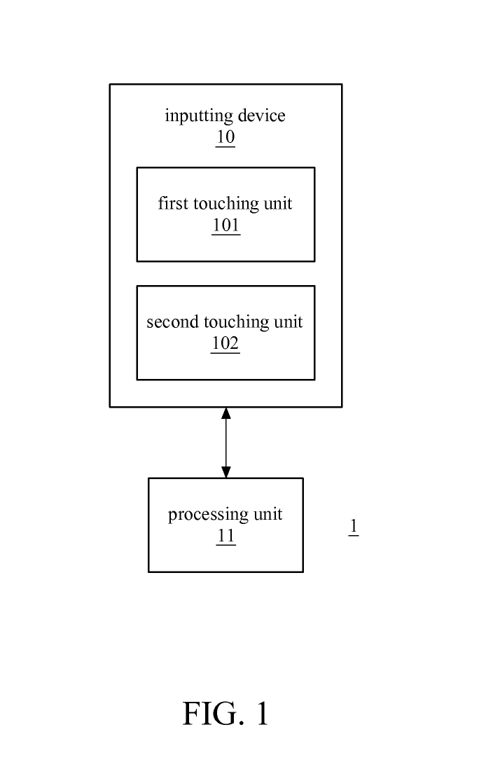

Please refer to FIG. 1, which is a block diagram of an input mode switching system in accordance with one embodiment of this invention. As shown in FIG. 1, the input mode switching system 1 may comprise an inputting device 10 and a processing unit 11. The inputting device 10 is, for example, embedded in a laptop computer and electrically coupled to the processing unit 11. The processing unit 11 is, for example, a central processing unit of the laptop computer or a controlling chip for processing input signals, and the processing unit 11 is used for analyzing signals or information sent by the inputting device 10. The inputting device 10 is, for example, a touch pad and comprises a first touching unit 101 and a second touching unit 102. In the present embodiment, the first touching unit 101 may be used in a keyboard inputting mode and may have keyboard icons on its surface while the second touching unit 102 may be used in a touch inputting mode.

Firstly, when a user touches the inputting device 10 with his/her finger(s), the inputting device 10 may sense the touching of the finger, i.e., the first touch, and therefore produce a first inputting signal to output to the processing unit 11. The processing unit 11 then determines whether the first touch is sensed by the first touching unit 101 and the second touching unit 102 according to the first inputting signal. That is, the processing unit 11 may determines whether the finger of the user is touching the first touching unit 101 and the second touching unit 102 so as to switch the inputting device 10 to a corresponding operation mode.

If the processing unit 11 determines the first touch is sensed by the first touching unit 101 and the second touching unit 102, the inputting device 10 is then switched to a mirror mode to be operated. On the contrary, if the processing unit 11 determines the first touch is not sensed by the first touching unit 101 and the second touching unit 102, the inputting device 10 is then switched to a normal mode or a gesture mode. Please refer to

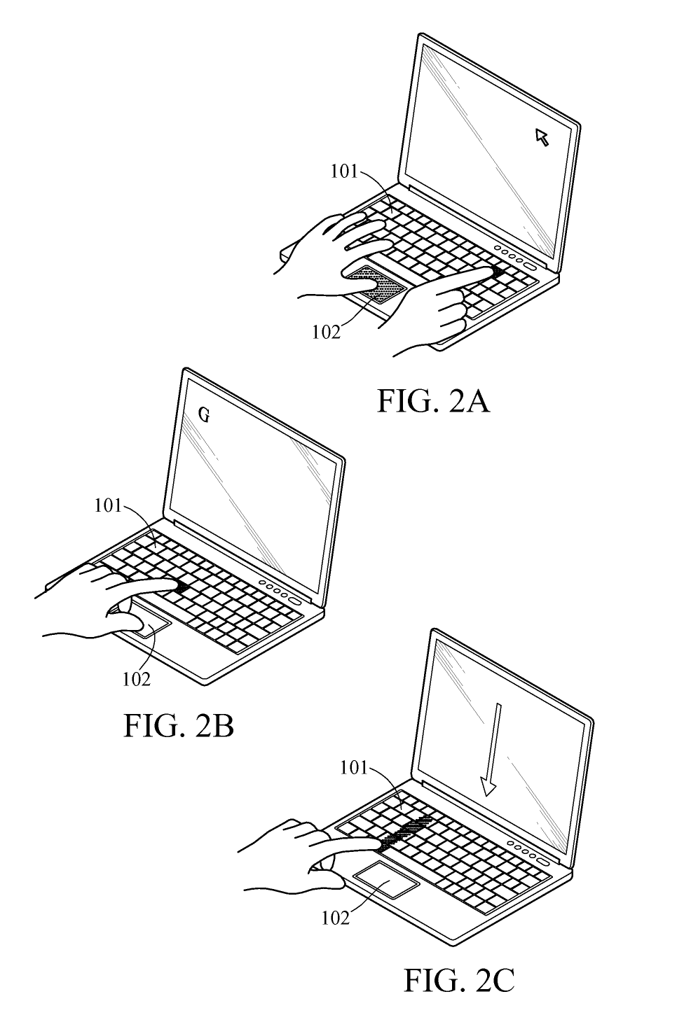

FIG. 2A, which illustrates an embodiment of this invention that a user touches the first touching unit and the second touching unit at the same time, but such embodiment is not to limit the scope of this invention.

Please refer back to FIG. 1, when the inputting device 10 is to be switched to the normal mode or the gesture mode, the processing unit 11 then determines whether the first touch is sensed by the first touching unit 101. In other words, the processing unit is to determine which touching unit among the first touching unit 101 and the second touching unit 102 is touched by the user's finger. If it is determined that the first touching unit 101 senses the first touch, the processing unit 11 then determines whether the first touch is an one touch operation.

If the first touch is determined by the processing unit 11 as the one touch operation, the processing unit 11 then switches the inputting device 10 to the normal mode. If the first touch is not the one touch operation, the processing unit 11 then determines whether the first touch is a gesture operation. If the processing unit 11 determines that the first touch is the gesture operation, the processing unit 11 switches the inputting device 10 to a gesture mode. Specifically, the one touch operation usually occurs when the user is inputting words with a keyboard. Hence, when the inputting device 10 is switched to the normal mode and the first touch is determined as the one touch operation, the processing unit 11 controls the first touching unit 101 to provide a functionality of a keyboard and controls the second touching unit 102 to provide a functionality as a touch pad. Practically, please refer to FIG. 2B, which illustrates an embodiment of this invention that a user touches the first touching unit to make the first touching unit provide a functionality of a keyboard. In one embodiment, the finger in FIG. 2B may directly touch the first touching unit 101. In another embodiment, the finger in FIG. 2B may not directly touch the first touching unit 101.

In one embodiment, please refer back to FIG. 1; the inputting device 10 may further generate a second inputting signal. the processing unit 11 may determines whether the second inputting signal is produced by the first touching unit 101 sensing a second touch. If the processing unit 11 determines that the second inputting signal is produced by the first touching unit 101 sensing the second touch, the processing unit 11 controls the inputting device 10 to output a touching signal because the user touches the first touching unit 101. Otherwise, the second inputting signal is produced by an object approaching but not touching the first touching unit 101. The object may be a stylus or a finger. If the processing unit 11 determines that the second inputting signal is produced by the object approaching the first touching unit 101, the processing unit 11 controls the inputting device 10 to output indicating signal. The indicating signal may comprise information corresponding to a key on the first touching unit 101 touched by the object so that the display of the laptop computer may display an image or a word corresponding to the key according to the indicating signal. For example, if a finger of the user is above the key “G”, the display of the laptop computer will display the word “G.” If the display displays a virtual keyboard, a virtual key of the virtual keyboard will be marked if a position on the first touching unit 101 of a finger of the user is corresponding to the marked virtual key. In addition, the inputting device 10 may further have a detecting unit of the first touching unit 101. The detecting unit is used for determining whether an object approaching the first touching unit 101.

When the inputting device 10 is switched to the gesture mode, the first touching unit 101 may provide a functionality of the gesture touching operation and the second touching unit 102 may provide a functionality of the touch pad. That is, the user may touch the first touching unit 101 to perform a gesture touching operation to generate a first touch. In one embodiment, FIG. 2C illustrates an example a user touch the first touching unit with a finger to perform the gesture touching operation. The first touching unit 101 produces a first inputting signal corresponding to a track of the object on the first touching unit 101. The processing unit 11 then receives the first inputting signal and performs corresponding operation(s) according to the first inputting signal. Furthermore, the operation corresponding to the second touching unit 102 is similar.

Please refer back to FIG. 1, when the inputting device 10 is switched to the mirror mode, the first touching unit 101 may provide a functionality of a curser operation and the second touching unit 102 may provide a functionality of a clicking operation of a mouse. That is, the user performs the curser moving operation with his finger on the first touching unit 101 to produce the first touch. The first touching unit 101 may produce the first inputting signal having information corresponding to a track of the finger on the first touching unit 101. The processing unit 11 then receives the first inputting signal and performs a corresponding operation according to the first inputting signal. Meanwhile, the processing unit 11 will map the first touching unit 101 to the display of the laptop computer. Specifically, when the user touches the upper left corner of the first touching unit 101, a curser may be displayed at the upper left corner of the display. When the user touches the lower right corner of the first touching unit 101, a curser may be displayed at the lower right corner of the display. With such manner, the user may easily control the laptop computer to select a selection of the menu displayed on the display.

In another embodiment, the processing unit 11 determines whether the first inputting signal is produced by the first touching unit 101 sensing the first touch. If the first touching unit 101 senses the first touch, the processing unit 11 controls the inputting device 10 to output the touching signal. Otherwise, the first inputting signal is produced by an object approaching the first touching unit 101. That is, the object is not touching the first touching unit 101 but is within a certain distance from the first touching unit 101. If the processing unit 11 determines that the first inputting signal is produced by an object approaching the first touching unit 101, the processing unit 11 controls the inputting device 10 to output the indicating signal. The processing unit 11 receives the indicating signal and performs a corresponding operation according to the indicating signal. The processing unit 11 will map the first touching unit 101 to the display. The indicating signal may comprise information corresponding to a position the object above the first touching unit 101 so that the laptop computer may display a curser at a corresponding position on the display according to the indicating signal. Additionally, the first touching unit 101 further provides a first clicking functionality and the second touching unit 102 further provides a second clicking functionality. That is, the user may have his finger above the first touching unit 101 to move the curser, have his finger touching the first touching unit 101 to generate the first touch, and touching the second touching unit 102 to generate the second touch. The first touching unit 101 may produce the first inputting signal according to the first touch. The processing unit 11 receives the first inputting signal and performs a corresponding operation, such as a left button clicking, accordingly. The second touching unit 102 may produce the second inputting signal according to the second touch. The processing unit 11 receives the second inputting signal and performs a corresponding operation, such as a right button clicking, accordingly.

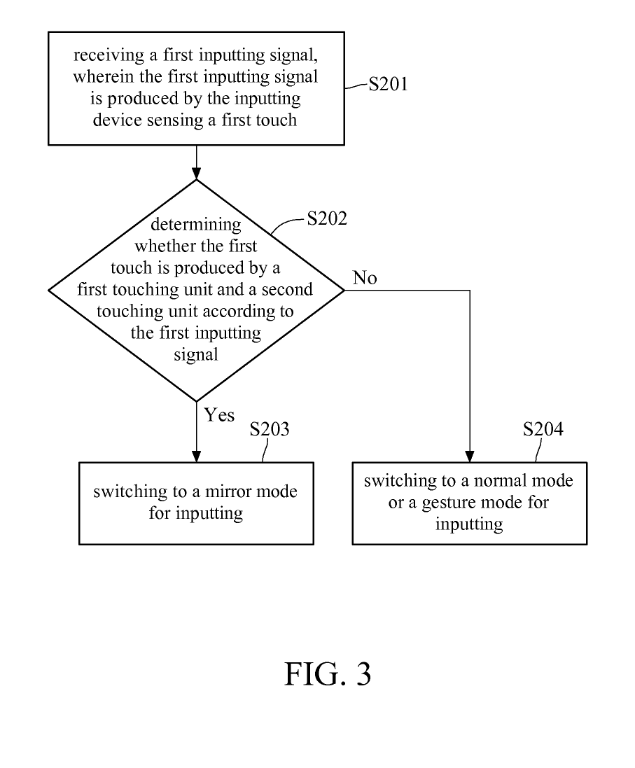

As above, an input mode switching method is disclosed in one embodiment of this invention. Please refer to FIG. 3, which is a flow chart of the input mode switching method in accordance with one embodiment of this invention. The disclosed method is applicable for the inputting device with a first touching unit and a second touching unit. As shown in step S201, the processing unit 11 receives a first inputting signal, wherein the first inputting signal is produced by the inputting device sensing a first touch. As shown in step S202, the processing unit 11 determines whether first touch is sensed by the first touching unit 101 and the second touching unit 102 according to the first inputting signal.

If the first touch is sensed by the first touching unit 101 and the second touching unit 102, as shown in step S203, the processing unit 11 switches the inputting device 10 to be operated in the mirror mode. Otherwise, as shown in step S204, the processing unit 11 switches the inputting device 10 to be operated in the normal mode or in the gesture mode.

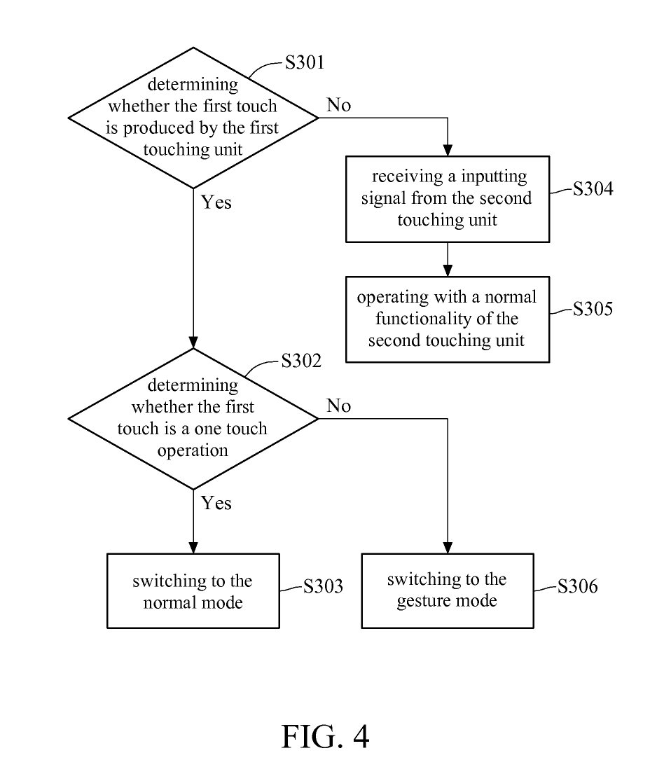

Please refer to FIG. 4, which is a flow chart of the step S204 of FIG. 3 in accordance with one embodiment of this invention. As shown in step S301, the processing unit 11 determines whether the first touch is sensed by the first touching unit 101. Practically, the first touch may be sensed by the first touching unit 101, such as a keyboard, or the second touching unit 102, such as a touch pad. Further, the first touching unit 101 and the second touching unit 102 may corresponds to different functionalities, so it is to be determined which functionality the user intends to operate. If the first touch is sensed by the second touching unit 102, as shown in step S304, the processing unit 11 begins to receive inputting signal(s) from the second touching unit 102. As shown in step S305, the processing unit 11 controls the inputting device 10 to be operated with a normal functionality of the second touching unit 102.

If the first touch is to sensed by the first touching unit 101, as shown in step S302, the processing unit determines whether the first touch is an one touch operation. If the first touch is the one touch operation, as shown in step S303, the processing unit 11 switches the inputting device 10 to the normal mode. Otherwise, as shown in step S306, the processing unit 11 switches the inputting device 10 to the gesture mode.

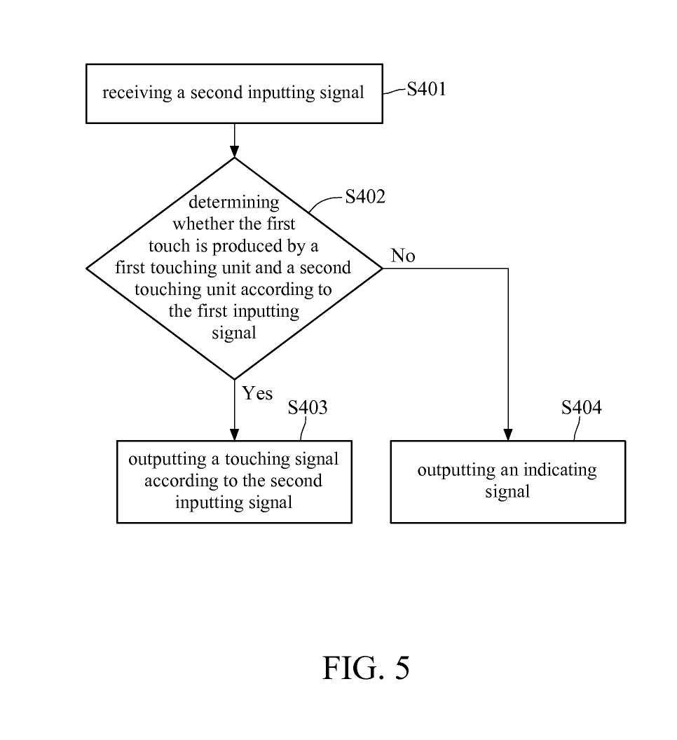

Please refer to FIG. 5, which is a flow chart after the step S303 of FIG. 4 in accordance with one embodiment of this invention. As shown in step S401, the processing unit 11 receives a second inputting signal. As shown in step S402, the processing unit 11 determines whether the second inputting signal is produced by the first touching unit 101 sensing a second touch. If the second inputting signal is produced by the first touching unit 101 sensing the second touch, as shown in step S403, the processing unit 11 controls the inputting device 10 to output a touching signal according to the second inputting signal. Otherwise, as shown in step S404, the processing unit 11 controls the inputting device 10 to output an indicating signal.

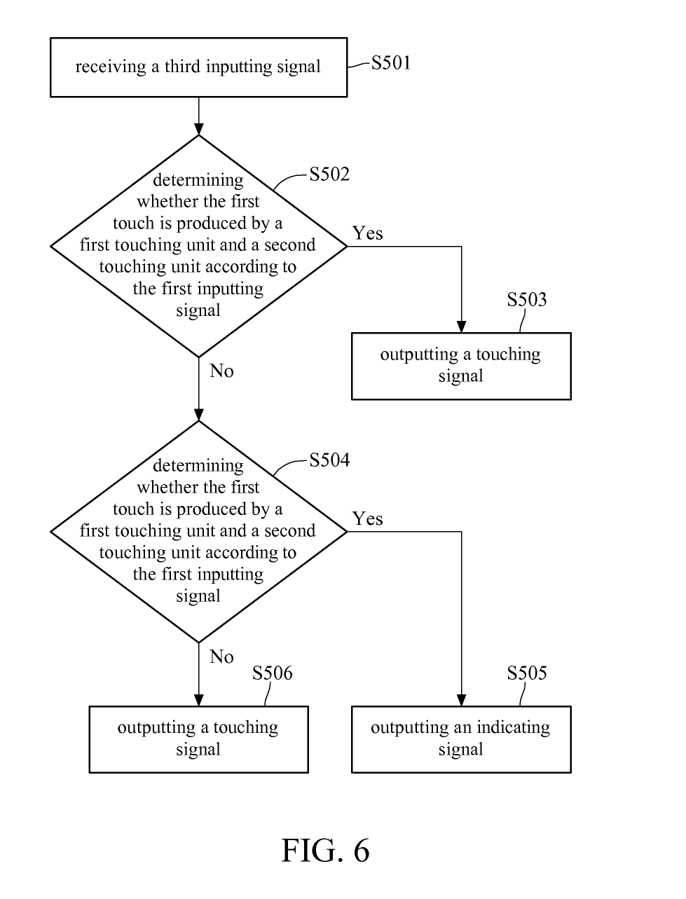

Please refer to FIG. 6, which is a flow chart after the step S203 of FIG. 3 in accordance with one embodiment of this invention. As shown in step S501, the processing unit 11 receives a third inputting signal. As shown in step S502, the processing unit 11 determines whether the third inputting signal is produced by the second touching unit 102 sensing a third touch. If the third inputting signal is produced by the second touching unit 102 sensing the third touch, as shown in step S503, the processing unit 11 controls the inputting device 10 to output the touching signal. Otherwise, as shown in step S504, the processing unit 11 determines whether the third inputting signal is produced by an object approaching the first touching unit 101. If the third inputting signal is produced by an object approaching the first touching unit 101, as shown in step S505, the processing unit 11 controls the inputting device 10 to output the indicating signal. Otherwise, as shown in step S506, the processing unit 11 controls the inputting device 10 to output a corresponding touching signal.

The input mode switching method and system determines whether a first touch is sensed by the first touching unit and the second touching unit by receiving a first inputting signal produced by the inputting device sensing the first touch, and switching to a mirror mode, a normal mode, or a gesture mode according to the determination. As such, a user may easily and efficiently switch the operation mode when using the disclosed system.

It will be apparent to those skilled in the art that various modifications and variations can be made to the disclosed embodiments. It is intended that the specification and examples be considered as exemplary only, with a true scope of the invention being indicated by the following claims and their equivalents.

What is claimed is:

1. An input mode switching method, applicable for an inputting device having a first touching unit and a second touching unit, the input mode switching method comprises:
receiving a first inputting signal, wherein the first inputting signal is produced by the inputting device sensing a first touch;
determining whether the first touch is sensed by a first touching unit and a second touching unit according to the first inputting signal;
switching the inputting device to a mirror mode for inputting if the first touch is sensed by the first touching unit and the second touching unit; and
switching the inputting device to a normal mode or a gesture mode for inputting if the first touch is not sensed by the first touching unit and the second touching unit.

2. The input mode switching method according to claim 1, wherein the step of switching the inputting device to a normal mode or a gesture mode for inputting comprises:
determining whether the first touch is sensed by the first touching unit;
determining whether the first touch is a one touch operation if the first touch is sensed by the first touching unit;
switching the inputting device to the normal mode for inputting if the first touch is the one touch operation; and
switching the inputting device to the gesture mode for inputting if the first touch is not the one touch operation.

3. The input mode switching method according to claim 2, wherein after the step of switching the inputting device to the normal mode for inputting, the input mode switching method further comprises:
receiving a second inputting signal;
determining whether the second inputting signal is produced by the first touching unit sensing a second touch according to the second inputting signal;
outputting a touching signal by the inputting device if the second inputting signal is produced by the first touching unit sensing the second touch; and
outputting an indicating signal by the inputting device if the second inputting signal is not produced by the first touching unit sensing the second touch.

4. The input mode switching method according to claim 1, wherein after the step of switching the inputting device to a mirror mode for inputting, the input mode switching method further comprises:
receiving a third inputting signal;
determining whether the third inputting signal is produced by the second touching unit sensing a third touch;
outputting a touching signal if the third inputting signal is produced by the second touching unit sensing the third touch;
determining whether the third inputting signal is produced by an object approaching the first touching unit if the third inputting signal is not produced by the second touching unit sensing the third touch; and
outputting an indicating signal if the third inputting signal is produced by the object approaching the first touching unit.

5. The input mode switching method according to claim 1, wherein the first touching unit is a touching keyboard inputting area and the second touching unit is a touching pad inputting area.

6. An input mode switching system, comprising:
an inputting device for sensing a first touch, comprising:
a first touching unit; and
a second touching unit; and
a processing unit connected to the inputting device, for receiving a first inputting signal from the inputting device, determining whether the first touch is sensed by the first touching unit and the second touching unit according to the first inputting signal, switching the inputting device to a mirror mode for inputting if the first touch is sensed by the first touching unit and the second touching unit, and switching the inputting device to a normal mode or a gesture mode for inputting if the first touch is not sensed by the first touching unit and the second touching unit, wherein the first inputting signal is produced by the inputting device sensing a first touch.

7. The input mode switching system according to claim 6, wherein when the inputting is switched to the normal mode or the gesture mode, the processing unit determines whether the first touch is sensed by the first touching unit, determines whether the first touch is a one touch operation if the first touch is sensed by the first touching unit, switches the inputting device to the normal mode for inputting if the first touch is the one touch operation, and switches the inputting device to the gesture mode for inputting if the first touch is not the one touch operation.

8. The input mode switching system according to claim 7, wherein when the inputting is switched to the normal mode, the processing unit receives a second inputting signal, determines whether the second inputting signal is produced by the first touching unit sensing a second touch according to the second inputting signal, outputs a touching signal by the inputting device if the second inputting signal is produced by the first touching unit sensing the second touch, and outputs an indicating signal by the inputting device if the second inputting signal is not produced by the first touching unit sensing the second touch.

9. The input mode switching system according to claim 6, wherein when the inputting device is switched to the mirror mode, the processing unit receives a third inputting signal and determines whether the third inputting signal is produced by the second touching unit sensing a third touch, outputs a touching signal if the third inputting signal is produced by the second touching unit sensing the third touch, determines whether the third inputting signal is produced by an object approaching the first touching unit if the third inputting signal is not produced by the second touching unit sensing the third touch, and outputs an indicating signal if the third inputting signal is produced by the object approaching the first touching unit.

10. The input mode switching system according to claim 6, wherein the first touching unit is a touching keyboard inputting area and the second touching unit is a touching pad inputting area.
